(19) United States
(12) Patent Application Publication
(10) Pub. No.: US 2014/0032081 A1
(43) Pub. Date: Jan. 30, 2014

(54) Dual Mode Engine Using Two or More Fuels and Method for Operating Such Engine

(71) Applicants: Martin Willi, Dunlap, IL (US); Christopher R. Gehrke, Chillicothe, IL (US)

(72) Inventors: Martin Willi, Dunlap, IL (US); Christopher R. Gehrke, Chillicothe, IL (US)

(73) Assignee: CATERPILLAR INC., Peoria, IL (US)

(21) Appl. No.: 13/559,887

(22) Filed: Jul. 27, 2012

(51) Int. Cl. F02D 41/34; F02M 51/06

(52) U.S. Cl. 701/104; 123/478

(57) ABSTRACT

An internal combustion engine includes a first fuel injector configured to inject a first fuel into an engine cylinder in response to a first injection signal, a second fuel injector configured to inject a second fuel into the engine cylinder in response to a second injection signal, and a third fuel injector configured to inject a third fuel into the engine cylinder in response to a third injection signal. The first, second and third fuels have different reactivities. An electronic controller provides, as appropriate, first, second and third injection signals using an engine speed and an engine load signals as primary control parameters such that the engine operates in at least two different combustion modes.

### TECHNICAL FIELD

This patent disclosure relates generally to internal combustion engines and, more particularly, to internal combustion engines that operate in more than one mode using more than one fuel.

### BACKGROUND

Internal combustion engines operating with more than one fuel are known. Certain engines use two or more fuels having different reactivities. One example of such an engine can be seen in U.S. Patent Application Pub. No. 2011/0192367, which was published on Aug. 11, 2011 to Reitz et al. (hereafter, “Reitz”). Reitz describes a compression ignition engine that uses two or more fuel charges having two or more reactivities to control the timing and duration of combustion. However, as Reitz describes, engine power output and emissions depends on the reactivity of the fuels, temperature, equivalence ratios and many other variables, which in real-world engine applications cannot be fully controlled. For example, fuel quality may change by season or region, and the temperature of incoming air to the engine depends on the climatic conditions in which the engine operates. Moreover, other parameters such as altitude and humidity can have an appreciable effect on engine operation.

Engine combustion systems that use stratified fuel/air regions in the cylinder having different reactivities, such as that described by Reitz, are known to work relatively well at low loads, where the various strata within the cylinder have a chance to fully develop, but the technology is not proven to work for higher loads, where the fuel amounts within the cylinder are increased and/or the incoming air to the cylinder is accelerated. Thus, the combustion system of Reitz may not be suitable for certain engine applications where higher speeds and loads are required.

### SUMMARY

The disclosure describes, in one aspect, an internal combustion engine. The internal combustion engine includes a first fuel injector that is configured to inject a first fuel into an engine cylinder in response to a first injection signal provided to the first fuel injector by an engine controller, a second fuel injector configured to inject a second fuel into the engine cylinder in response to a second injection signal provided to the second fuel injector by the engine controller, and a third fuel injector configured to inject a third fuel into the engine cylinder in response to a third injection signal provided to the third fuel injector by the engine controller. The second fuel has a different reactivity than the first fuel, and the third fuel has a different reactivity than the first and second fuels. The engine controller is configured to provide, as appropriate, the first, second and third injection signals using an engine speed and an engine load signals as primary control parameters such that the engine operates in at least two different combustion modes.

In another aspect, the disclosure describes an internal combustion engine that includes an engine cylinder formed in a cylinder case and at least partially defining a variable volume. The variable volume is in selective fluid connection with an air source via an intake port. A first fuel injector is configured to inject a first fuel directly into the variable volume. A second fuel injector is configured to inject a second fuel directly into the variable volume. A third fuel injector is configured to inject a third fuel into the intake port. In one embodiment, the second fuel has a different reactivity than the first fuel, and the third fuel has a different reactivity than the first and second fuels. A speed sensor is configured to provide an engine speed signal, and a load sensor is configured to determine and provide an engine load signal. A controller configured to receive and analyze the engine speed and load signals provides a first injection signal to the first injector, a second injection signal to the second injector, and a third injection signal to the third injector such that the engine operates in a first mode or a second mode as determined by the engine speed and load signals.

In yet another aspect, the disclosure describes a method for operating an internal combustion engine. The method includes monitoring engine speed and engine load signals and determining a then-present operating point of the engine. The then-present operating point of the engine is analyzed to determine whether at least a first operating mode or a second operating mode is desired based on the then-present operating point of the engine. When it is determined that the first operating mode is desired, appropriate commands are sent to fuel injectors of the engine to inject fuels such that stratified regions of air/fuel mixtures having different reactivities are set up within an engine cylinder during operation. When it is determined that the second operating mode is desired, appropriate commands are sent to fuel injectors of the engine to deliver desired quantities of one or more than fuels into the engine cylinder, and an appropriate command is sent to an additional fuel injector to provide an ignition substance into an air inlet port of the engine cylinder.

### BRIEF DESCRIPTION OF THE DRAWINGS

FIG. 1 is a block diagram for an engine system in accordance with the disclosure.

FIG. 2 is an engine lubrication system block diagram in accordance with the disclosure.

FIG. 3 is a graphical representation of an exemplary engine power curve in accordance with the disclosure.

FIGS. 4-7 are cross sections of an engine cylinder at various operating positions in accordance with the disclosure.

FIG. 8 is a block diagram for a fuel injector control module in accordance with the disclosure.

FIG. 9 is a flowchart for a method of operating an engine in accordance with the disclosure.

### DETAILED DESCRIPTION

The present invention relates generally to an internal combustion engine that operates using two different fuels under more than one operating mode. Specifically, the disclosure describes an engine that can operate in a first mode using first and second fuels. The engine is configured to operate in at least a second mode using either the first or second fuel and a third fuel. The engine may further operate in a third, hybrid mode using one, two or all three different fuels. In one described embodiment, the engine is configured to operate using a reactivity controlled compression ignition (RCCI) combustion system under relatively low engine speed and load conditions. When operating at higher engine speeds and loads, engine operation shifts to a distributed ignition (DI) combustion system. A hybrid combustion system having attributes similar to RCCI and DI may be present during a transition range between the RCCI and DI operating modes of the engine.

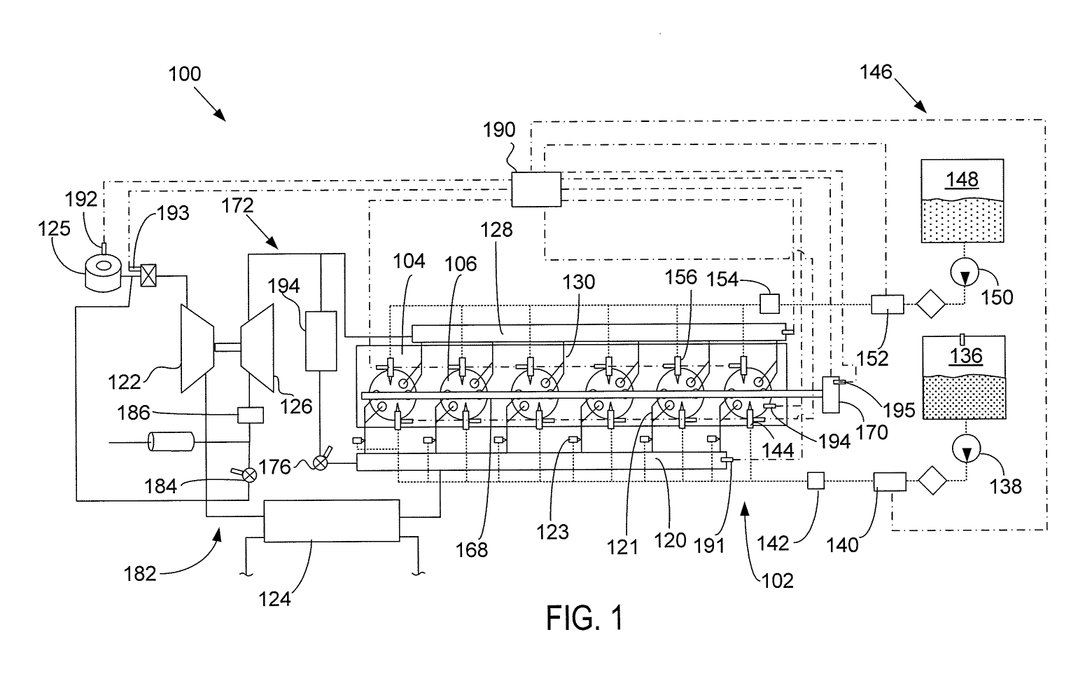

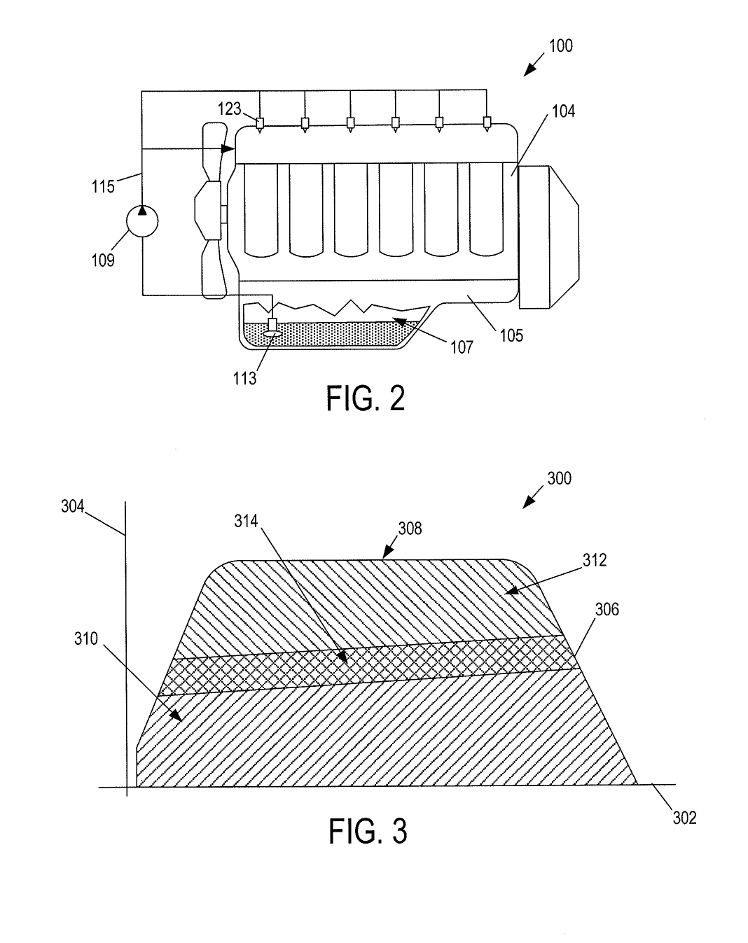

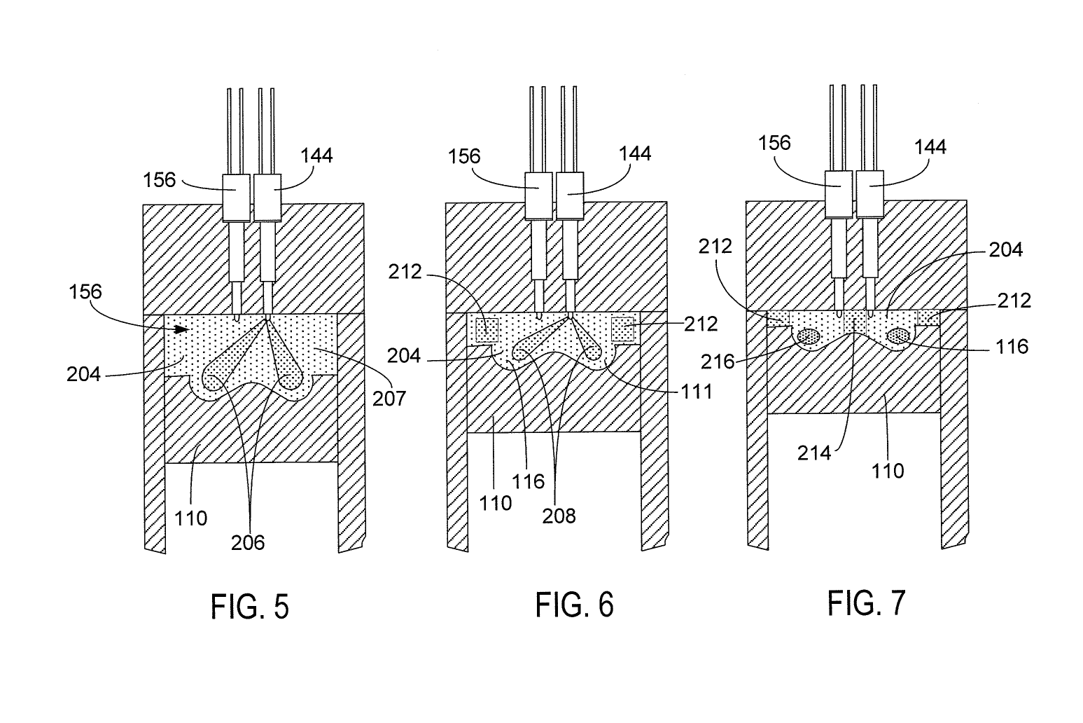

A block diagram for an engine system 100 is shown in FIG. 1. The engine system 100 includes an engine 102 having a cylinder case 104 that forms a plurality of engine cylinders 106. A partial cross section of the cylinder case 104 is shown in FIG. 2. Although six cylinders 106 are shown, fewer or more cylinders arranged in an inline or another configuration such as a V-configuration may be used. As shown in FIG. 4, each engine cylinder 106 includes a bore 108 that slidably accepts therein a piston 110. The piston 110 forms a bowl 111 in its crown. A free end of the bore 108 is closed by what is commonly referred to as a flame deck surface 112 of a cylinder head 114. In this way, a variable volume 116 is defined between a top portion of the piston 110, the bore 108 and the flame deck surface 112, which varies as the piston 110 moves between top dead center (TDC) and bottom dead center (BDC) positions within the bore 108.

In the illustrated embodiment, an intake valve 118 selectively fluidly connects the variable volume 116 with an intake manifold or collector 120 (FIG. 1) via an intake port 121. The intake manifold 120 receives air compressed by a compressor 122, which can optionally also be cooled in an intercooler 124 before entering the intake manifold 120. Air is provided to the compressor 122 through an air filter 125. Power to compress the air in the compressor 122 is provided by a turbine 126, which receives exhaust gas from an exhaust manifold or collector 128. When combustion in each cylinder is complete, exhaust gas from each cylinder 106 is collected in the exhaust manifold 128 from one or more exhaust runners 130, which communicate with and are selectively fluidly connectable with their respective cylinders 106 via exhaust valves 132, which are best shown in FIG. 4. Although one intake and one exhaust valve 118 and 132 are shown in the cross section of FIG. 2, more than one intake and exhaust valve can be connected to each cylinder. For example, two intake and two exhaust valves 118 and 132 are shown for each cylinder 106 in FIG. 1.

The engine system 100 further includes an electronic controller 190, which monitors and controls the operation of the engine 102 and other components and systems associated with the engine such as fuel supply components and systems, as well as other structures associated with the engine such as machine components and systems and the like. More specifically, the controller 190 is operably associated with various sensors that monitor various operating parameters of the engine system 100. In FIG. 1, the various communication and command channels associated with the controller 190 are shown in dot-dashed lines for illustration but may be embodied in any appropriate fashion, for example, via electrical conductors carrying analog or digital electrical signals, via informational transfer channels within a local area computer network, via a confined area network (CAN) arrangement, and/or via any other known configuration.

In the exemplary embodiment of FIG. 1, the engine 102 is configured to operate in a first mode, for example, a RCCI mode, with first and second fuels having different reactivities such as diesel and gasoline. Both fuels are stored and supplied to the engine independently. Accordingly, a diesel fuel system 134 includes a diesel fuel reservoir 136 that supplies fuel to a diesel fuel pump 138. An optional diesel fuel conditioning module 140 may filter and otherwise condition the fuel that passes therethrough, for example, to heat the fuel at low temperature conditions, remove water, and the like. Pressurized diesel fuel is collected in a high-pressure rail or accumulator 142, from where it is provided to a fuel injector 144 associated with each cylinder 106. As is also shown in FIG. 4, the first fuel injector is a diesel fuel injector 144 associated with each cylinder 106, which is configured to inject a predetermined amount of diesel directly into the respective variable volume 116.

For the second fuel, a gasoline fuel system 146 includes a gasoline fuel reservoir 148 that supplies fuel to a gasoline pump 150. Although gasoline is described herein as the second fuel, a different fuel such as natural or petroleum gas may be used. In the illustrated embodiment, an optional gasoline conditioning module 152 may filter and otherwise condition the fuel that passes therethrough. Pressurized gasoline is provided to a high-pressure rail or accumulator 154, from where it is provided to a plurality of second fuel injectors, here, a plurality of gasoline injectors 156, each of which is associated with each cylinder 106 and is configured to inject a predetermined amount of gasoline directly into the respective variable volume 116. In alternative embodiments, the gasoline injectors 156 may be disposed to inject fuel indirectly into the cylinders 106, for example, by providing the fuel into the respective intake runner 121 or by dispersing the gasoline in an aerosol mixture with the intake air within the intake manifold 120 from one or more injection locations (not shown). Alternatively, if a gaseous fuel is used instead of gasoline, the gaseous fuel may be provided at a relatively low pressure into the intake manifold. Additionally, although two fuel injectors 144 and 156 are shown associated with each cylinder 106, a single fuel injector having the capability of injecting two fuels independently (not shown) can be used. For both the diesel and gasoline fuel systems 134 and 146, other additional or optional fuel system components such as low-pressure transfer pumps, de-aerators and the like can be used but are not shown for simplicity.

In addition to the first and second fuels discussed thus far, the engine can use a third fuel, for example, when the primary fuel provided to the cylinders is not suitable for controlled auto-ignition, i.e., when the primary fuel is gasoline, natural gas and the like. The term “fuel” in the context of the third fuel describes any substance that is provided into the cylinders 106 of the engine during operation and combusts. In one embodiment, the third fuel is lubrication oil of the engine 100. As shown in the block diagram of FIG. 2, the cylinder case 104 is connected to an oil pan 105 that forms an oil reservoir 107 into which a pool of oil is collected. Oil in the reservoir 107 is circulated through and over various engine and other components to cool and/or lubricate those components. Oil circulation is accomplished by a pump 109, which pulls oil from the reservoir through a sump 113 and provides oil at a supply pressure at an outlet 115. Oil from the outlet 115 is provided at the intermediate pressure to various engine components during operation, from where it returns to the reservoir 107, typically by force of gravity.

Relevant to the present disclosure, oil from the pump outlet 115 is provided to a plurality of third fuel injectors, here, oil injectors 123. In the illustrated embodiment, as shown in FIG. 1, one oil injector is associated with at least one of the intake ports 121 of each cylinder 106. Each oil injector 123 is configured to inject a predetermined amount of oil at a predetermined time and duration into the intake port 121 in which it is installed in response to command signals from the electronic controller 190 (FIG. 1). The oil injectors 123 are activated during an intake stroke to inject oil droplets or an oil mist into the respective cylinder 106. When oil is provided from the injectors 123, the oil droplets or oil mist is provided into the intake ports 121 during a time when air passes therethrough to enter the respective cylinder 106 through the intake valve 118. The speed and momentum of air flow within the respective intake port 121 carries the oil provided through the respective injector 123 into the cylinder 106. One example of an oil injector used in conjunction with an intake runner of a cylinder can be found in U.S. Pat. No. 5,870,978 (the '978 patent), which issued on Feb. 16, 1999 and which is incorporated herein in its entirety by this reference. The '978 patent describes an engine assembly in which natural gas and air are compressed in a combustion cylinder in the presence of oil, which initiates the combustion of the natural gas and air mixture.

In reference now to the cross section shown in FIG. 4, the intake and exhaust valves 118 and 132, in one embodiment, are actuated by pushrods 158, which push each valve to open when a respective lobe 160 of one or more rotatable camshafts 162 pushes onto a respective cam follower 164 via a valve bridge 166 in the known fashion. In the embodiment illustrated, the engine 102 has a variable cam timing, which enables the selective shifting and/or elongation of the opening stroke of the intake valves 118 and the exhaust valves 132. Accordingly, in the embodiment shown in FIG. 1, a single camshaft 168 is caused to rotate during engine operation. A phase angle of the camshaft can be selectively altered via a specialized actuator 170, which is responsive to a command signal. In general, the variable valve timing for the engine 102 can be accomplished in any known fashion, including the addition of devices and actuators (not shown) that act on the valve pushrods to keep the respective valve open for a prolonged period. Relative to shifting valve timing, various mechanisms can be used. One example of a variable valve timing arrangement that can operate to shift valve timing is described in co-pending U.S. patent application Ser. No. 12/952,033, which discusses a mechanism configured to provide a predetermined phase rotation of the camshaft relative to the engine crankshaft that results in a phase shift of valve opening and closing events during engine operation.

In one embodiment, the engine 102 can include an exhaust recirculation (EGR) system, which operates to draw exhaust gas from the engine's exhaust system that is mixed with intake air of the engine to displace oxygen and generally lower the flame temperature of combustion within the cylinders. Two exemplary EGR systems are shown associated with the engine 102 in FIG. 1, but it should be appreciated that these illustrations are exemplary and that either one, both, or neither can be used on the engine. It is contemplated that use of an EGR system of a particular type may depend on the particular requirements of each engine application.

A first exemplary embodiment of an EGR system is for a high-pressure EGR system 172 that includes an optional EGR cooler 174 and an EGR valve 176. The EGR cooler 174 and EGR valve 176 are connected in series between the exhaust and intake manifolds 128 and 120. This type of EGR system is commonly referred to as high-pressure loop system because the exhaust gas is recirculated from a relatively high-pressure exhaust location upstream of the turbine 126 to a relatively high-pressure intake location downstream of a compressor 122. In the EGR system 172, the exhaust gas is cooled in the EGR cooler 174, which may be embodied as a jacket cooler that uses engine coolant as a heat sink. The flow of exhaust gas is metered or controlled by the selective opening of the EGR valve 176, which can be embodied as any appropriate valve type such as electronically or mechanically actuated valves.

A second exemplary embodiment of a low-pressure loop EGR system 182 includes an EGR valve 184 that is fluidly connected between a low-pressure exhaust location downstream of the turbine 126 and a low-pressure intake location upstream of the compressor 122. As shown, the exhaust location is further disposed downstream of an after-treatment device 186, which can include various components and systems configured to treat and condition engine exhaust gas in the known fashion, and upstream of the intercooler 124, which can be embodied as an air-to-air cooler that removes heat from the intake air of the engine.

Relevant to the present disclosure, the engine system 100 includes an intake manifold pressure sensor 191 and an intake air temperature sensor 192 disposed to measure the pressure and temperature of incoming air to the engine and provide signals indicative of the measured parameters to the controller 190. As shown, the intake manifold pressure sensor 191 is disposed to measure air pressure within the intake manifold 120. The intake air temperature sensor 192 is disposed to measure incoming air temperature at the air filter 125. The engine system 100 further includes a barometric pressure sensor 193 that, as shown, is located at the air filter 125 and is disposed to measure and provide to the controller 190 a signal indicative of the barometric pressure and thus the altitude of engine operation.

The engine system 100 additionally includes a cylinder pressure sensor 194, which is configured to measure and provide to the controller 190, in real time, a signal indicative of fluid pressure within the cylinder 106 into which the sensor is placed. Although one sensor is shown, it should be appreciated that more than one cylinder may have such a pressure sensor associated therewith. A timing sensor 195 provides a signal to the controller 190 that is indicative of the rotational position of the crankshaft and/or camshaft. Based on this information, the controller 190 can infer, at all times, the position of each intake and exhaust valve 118 and 132 as well as the position of each piston 110 within its respective cylinder 106. This information can be used to control and adjust engine operation.

The controller 190 is further configured to provide commands to various actuators and systems associated with the engine 102. In the illustrated embodiment, the controller 190 is connected to the diesel and gasoline fuel injectors 144 and 156 and is configured to provide them with command signals that determine the timing and duration of fuel injection within the cylinders 106. Likewise, the controller 190 is connected to and controls the oil injectors 123. The controller 190 may further provide a timing phase command to the camshaft phase actuator 170 that dynamically adjusts valve timing during operation. As shown, the controller 190 further provides commands that control the operation of the diesel and gasoline fuel conditioning modules 140 and 152 when either or both of these modules include functionality operating to change or adjust fuel properties, for example, by mixing additives that affect the cetane rating or otherwise determine the reactivity of the respective fuels.

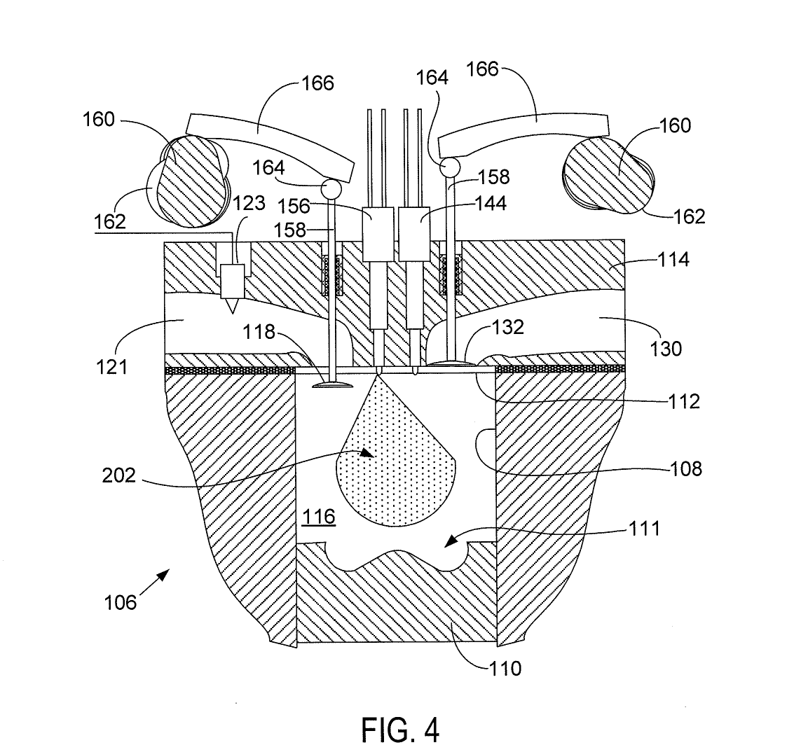

Operation of the engine 100 is carried out in more than one mode. A graph showing an exemplary engine power curve 300, which is plotted against engine speed on the horizontal axis 302 and engine load on the vertical axis 304, is shown in FIG. 3. The exemplary graph qualitatively illustrates an engine power curve 306, which is shown having a simplified shape for discussion. The power curve 306 forms a generally flat rated power output portion 308, which represents a maximum engine load output over a range of engine speeds. As shown, the area below the engine power curve 306, which represents a collection of various engine operating points in terms of specific combinations of engine speeds and loads, is segmented into three areas: a first area 310, which includes lower engine speed and load operating points, a second area 312, which includes higher engine speed and load operating points including the entire rated power output portion 308, and an intermediate area 314, which includes engine speed and load operating points that are between the low and high points belonging in the first and second areas 310 and 312.

The particular shape of the engine power curve 306 as well as that of the first, second and third areas 310, 312 and 314, are exemplary and may be changed depending on the requirements of particular engine applications. Moreover, the third area 314, which is generally a transition area of engine operating points between the first and second areas 310 and 312 is optional and may be omitted in favor of a curve representing a direct boundary between the first and second areas 310 and 312 on the chart 300. In other words, engine operating point belonging to the first and second areas may be discrete. Alternatively, the third area 314 may result from an overlap of the first and second areas 310 and 312.

In one embodiment, the engine 100 may operate in accordance with the graph 300 in which operating points belonging to the first area 310 represent engine operation under a reactivity controlled compression ignition (RCCI) combustion system (RCCI mode). Operating points belonging to the second area 312 represent engine operation under a distributed ignition (DI) combustion system (DI mode) and, optionally, points belonging to the third area 314 may represent a hybrid engine operating mode (hybrid mode) that includes aspects of RCCI and DI combustion. When operating in the RCCI mode, two fuels having different reactivities such as natural gas or gasoline, and diesel, are provided to the cylinders at different times to create stratified regions within the cylinder. RCCI mode can be carried out at low engine speeds and loads because the time within which the two fuels are injected is relatively longer, and the air speed of fluids entering the cylinder are relatively low. As engine speed and load increase, i.e. the operating point of the engine moves upwards and towards the right in the graph 300 (FIG. 3), the air speeds increase and the time between combustion events decreases. In these conditions, the engine combustion system begins to depart from a pure RCCI mode of operation and approaches the DI operating mode.

When operating in the DI mode, the engine uses primarily a single fuel such as natural gas, gasoline or diesel. Ignition is provided by injecting a small amount of a third fuel having a relatively high cetane number. In the illustrated embodiment, the third fuel is lubrication oil of the engine, which is provided to the cylinders through the air intake ports of the cylinders in the form of droplets or a mist injected through the oil injectors 123. As the engine transitions between the RCCI mode and the DI mode, i.e., as the engine operating point moves between the first and second areas 310 and 312 (FIG. 3), the transition between the RCCI and DI operating modes is accomplished by appropriate changes in the timing and duration of fuel injections commanded by the controller 190. These changes can take place instantaneously as the engine operating point shifts, or may occur gradually over a transition region. Alternatively, if the engine operating point happens to remain within the third area 314 of the graph 300, the hybrid mode may be implemented for a longer time than what is required to transition between the RCCI and DI modes. Gradual engine operating mode changes can be carried out over predetermined engine speed and load changes, for example, when the engine operating point resides or passes through the third area 314 of the graph 300.

An exemplary series of injection events for fuels having different reactivities that can be performed in accordance with one embodiment of the disclosure to provide operation in the RCCI mode, i.e., where the operating points of the engine fall within the first area 310 of the graph 300 such that stratified fuel/air mixture regions having different reactivities are provided within a cylinder during a compression stroke, are shown in the cross sections of FIGS. 4-7. Beginning with FIG. 4, an initial fuel charge having a first, low reactivity, for example, gasoline, is injected into the variable volume 116 while the piston 110 is still undergoing an intake stroke or shortly after the intake stroke has been completed. Delivery of the first fuel into the variable volume 116 can be accomplished by dispersion of a gasoline plume 202 that is provided through the gasoline fuel injector 156 early enough to permit a somewhat uniform concentration of gasoline vapor throughout the variable volume 116. In an alternative embodiment, the first fuel may be mixed with intake air as the intake air enters the cylinder through the intake port. In the illustrated embodiment, gasoline injection can be performed at any time during the intake stroke provided that egress of gasoline vapor from the cylinder into the intake manifold, for example, such as what may occur if gasoline vapors are present in the cylinder during a late intake closing Miller cycle, is avoided. After completion of the first injection shown in FIG. 4, sufficient time passes until a relatively uniform and homogeneous air/fuel mixture 204 (FIG. 5) having a first, relatively low reactivity occupies substantially the entire variable volume 116 of the cylinder.

The air/fuel mixture 204 having the first, relatively low reactivity is compressed at the early stage of a compression stroke while the piston 110 moves away from the BDC position and towards the TDC position, as shown in FIG. 5. At this stage, the second fuel, which has a higher reactivity such as diesel, is injected into the variable volume 116 through the diesel injector 144. As shown, a diesel plume 206 is injected into the variable volume anywhere between the BDC position of the piston 110 (180 degrees of crankshaft rotation before TDC) and 10 degrees before the TDC position (0 degree position). During this period, two or more diesel injections may be provided. The injection shown in FIG. 5 is provided in about the first half of the compression stroke of the piston 110 while the piston is at a relatively greater distance from the flame deck surface such that the second injection plume 206 is directed towards the outer peripheral portions of the variable volume 116, which are sometimes referred to as the squish regions 207 when describing pistons having a bowl and a raised rim that “squishes” fluids in conjunction with the flame deck surface as the piston approaches the TDC position.

A third injection of high-reactivity fuel (here, diesel) is shown in FIG. 6, which depicts a position of about 30 degrees before TDC. The third fuel injection plume (second diesel plume) 208 of this injection event is directed primarily towards the inner portion of the piston bowl 111 because of the relative proximity of the piston 110 to the injector 144. In the time after the second injection was completed and before this third injection occurs, the second injection plume 206 (FIG. 5) has begun to diffuse or has already diffused from the squish region and mixes with the low-reactivity air/fuel mixture 204 from the fuel charge from the first fuel injection plume 202 (FIG. 4) to form a region 212 of intermediate reactivity at or near the squish region, as shown in FIG. 6. The second diesel plume 208 also begins to diffuse such that, after completion of this injection event and as the piston 110 continues to travel towards TDC, at least two additional regions having different reactivities are created.

As shown in FIG. 7, following completion of the third injection, the regions of intermediate reactivity 212 remain in the squish region, and a new region of intermediate reactivity 214 forms along a central portion of the bore, primarily by diffuse fuel from the third injection event near a tip of the injector 144. The fuel from the third injection event, i.e. the second diesel plume 208, has also formed a third region 216 having relatively high reactivity within the piston bowl. The third region 216 is formed primarily by evaporation of high reactivity fuel provided during the third injection event within the relatively enclosed space of the piston bowl.

Overall, the variable volume 116 at the position near TDC as shown in FIG. 7 includes regions having three different reactivities, which are stratified relative to one another: (1) the background region made up from the air/fuel mixture 204 that occupies substantially the entire volume 116, which has a relatively low reactivity provided by the initial fuel injection charge 202 (FIG. 4) that has now substantially diffused, (2) the second and third regions 212 and 214 disposed in the squish region and along the central portion of the volume 116 that have intermediate reactivity, which were created by the second and third injection events, and (3) the relatively high reactivity region 216 that is disposed substantially within the piston bowl and was created after the third injection event. Combustion may begin at around this time at the high reactivity region 216 and propagate over time to the intermediate and lower reactivity regions 204, 212 and 216.

Combustion under the DI mode, for example, when the engine operating point resides in the second area 312 of the graph 300 (FIG. 3), is relatively simpler. In this operating condition, a single fuel such as natural gas, gasoline or diesel is provided in the combustion cylinder during the compression stroke and is allowed to relatively uniformly disperse. Also present in the cylinder is a substance that acts as an ignition initiator. In the illustrated embodiment, the ignition initiator substance is lubrication oil, which is provided in the form of droplets or a mist into the air intake port of each cylinder and is carried by the intake air into the cylinder during an intake stroke. The relatively high cetane rating of lubrication oil, which can be in the order of 70-90, initiates combustion, which spreads to and is maintained by the uniformly distributed fuel that is injected directly into the cylinder.

As can be appreciated, operation in RCCI mode requires the injection of two fuels, while operation in DI mode requires the injection of at least a single fuel and the provision of yet another, third fuel, which may serve as an ignition source under certain engine operating conditions. When engine operation transitions between these two modes, the operation of the first, second and third fuel injectors 144, 156 and 123 can determine the type and quantity of each fuel that is present in the cylinder, which in turn can determine the combustion mode of the cylinder. Further, when a third, hybrid mode of operation is carried out in transition regions, such as the third area 314 (FIG. 3), all three fuels may be provided to the cylinder. For example, when moving from an RCCI mode towards a DI mode, the first and second fuels may be provided in a stratified fashion into the cylinder as previously described. As the engine speed increases, the time to develop the various strata of regions with different reactivities may not be available and thus lead to mixing of the various strata.

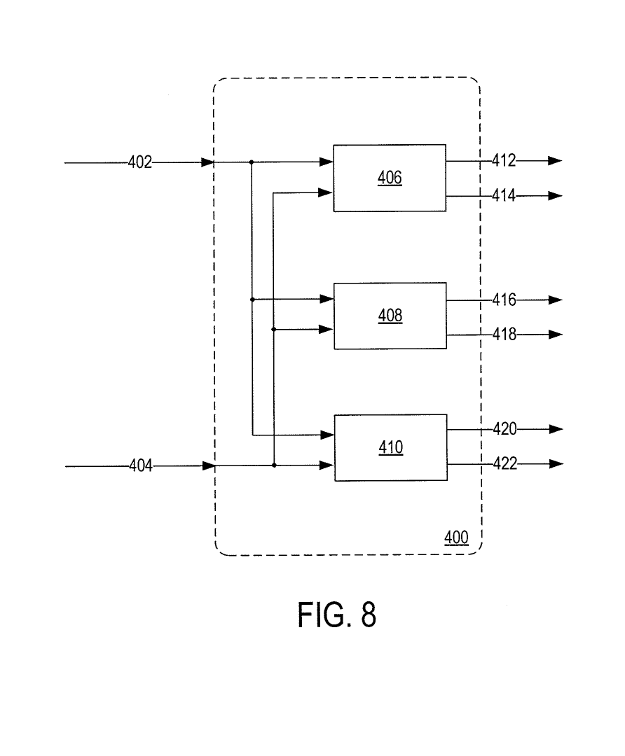

To ensure predictable and controllable ignition under such conditions, the third fuel may be provided via the oil injector 123. The presence of the third fuel in the cylinder may ensure combustion initiation in a quasi-DI operating mode. Thereafter, as engine speed further increases, one of the two fuel injectors participating in carrying our the RCCI operating mode may stop operating or, alternatively, both may continue operating to a certain extent but not necessarily to provide stratified regions. Instead, and for example, the two fuel injectors may simply operate to provide a total desired amount of fuel into the cylinder, ignition for which will be provided by the third fuel. The determination in the electronic controller of which combustion mode will be carried out is made based the engine operating point. These parameters can be provided to one, two or three different mode-operating functions, as shown in the block diagram of FIG. 8.

FIG. 8 illustrates an engine control module 400, which is operating within the controller 190 and is configured to control the operation of the engine and especially the operation of the first, second and third fuel injectors 144, 156 and 123. The control module 400 receives information indicative of engine operating parameters including engine speed (RPM) 402 and engine load (TQ) 404 signals. These signals may be provided by sensors disposed on the engine or estimated, for example, by a transmission or other controller as is known. Each of the engine speed and load signals 402 and 404 is provided to three fuel maps 406, 408 and 410. Each fuel map 406, 408 and 410 is populated with injection timing and duration values for a respective fuel injector. Accordingly, the first fuel map 406 is configured to control the first fuel injector 144, which is configured to directly inject the first fuel, here, diesel, into the engine cylinders. The first fuel map 406, based on the engine speed and load signals 402 and 404, provides a diesel injection timing signal 412 and a diesel injector duration signal 414 to the diesel fuel injector 144. In a similar fashion, and based on the same inputs, the second fuel map 408 provides gasoline (or gas) injector timing and duration signals 416 and 418 to the gasoline fuel injector 156, and the third fuel map 410 provides oil injector timing and duration signals 420 and 422 to the oil injector 123.

As can be appreciated, when the engine is operating in RCCI mode, the fuel commands are primarily provided by the first and second fuel maps 406 and 408. When the engine is operating in DI mode, fuel commands are primarily provided by the first and/or second fuel maps 406 and 408, and also by the third fuel map 410. When the engine is operating in hybrid RCCI/DI mode, for example, as illustrated by the third area 314 (FIG. 3), fueling commands are provided by all three fuel maps 406, 408 and 410.

### INDUSTRIAL APPLICABILITY

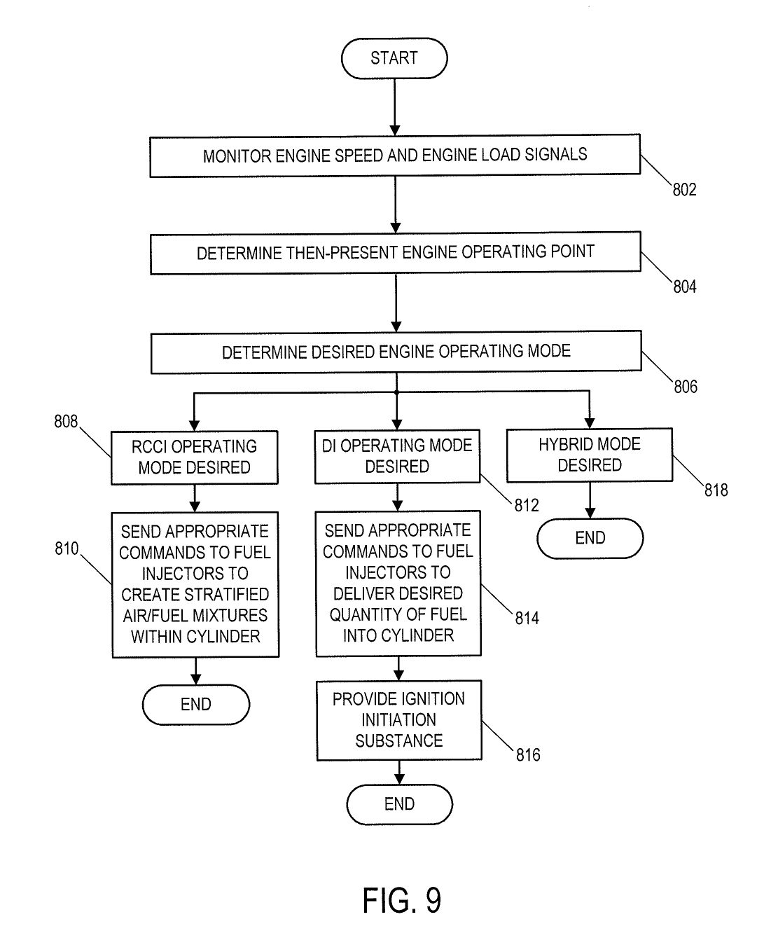

A flowchart for a method of operating an engine using two or more fuels in two or more combustion modes is shown in FIG. 9. The various process steps described can be carried out in any order. In the flowchart shown in FIG. 8, engine speed and load signals are monitored at 802. These signals may be directly measured by sensors associated with the engine or may alternatively be estimated based on other operating parameters. For example, the engine speed may be determined by monitoring a crankshaft or camshaft sensor, while the torque may be based on a commanded torque or may alternatively be based on an estimated torque at a transmission. The engine speed and load serve as an indication of the then-present operating point of the engine, which is determined at 804.

The engine operating point determined at 804 is analyzed in the context of at least two predetermined engine operating ranges. The engine operating ranges include an engine operating range under which RCCI operation is desired and an engine operating range under which DI operation is desired. Optionally, a third, hybrid engine operating range can be defined between the RCCI and DI ranges. Operation in this hybrid engine operating range may involve operation under both RCCI and DI operating modes. Each range may be defined to be present for a particular group or subset of engine speed and load operating points. Based on the analysis, a determination of which operating mode is desired is carried out at 806.

When it is determined based on the engine operating point that the RCCI mode is desired at 808, the controller operates at 810 to send appropriate commands to fuel injectors to inject fuels such that stratified regions of air/fuel mixtures having different reactivities are set up within the engine cylinders during operation. When it is determined that the DI mode is desired at 812, the controller operates at 814 to send appropriate commands to one or more fuel injectors to deliver a desired quantity of one or more fuels into the engine cylinders. Also, the controller commands at 816 a third injector to provide an ignition initiation substance into an air inlet port of the engine, which will initiate DI combustion. In one embodiment, the initiation substance is engine lubrication oil, the first fuel is diesel and the second fuel is gasoline or natural gas. Optionally, the controller may operate at 818 in a hybrid mode, which can be present when the engine operating point is passing between RCCI and DI modes or when the engine operating point happens to reside in an engine speed and load combination that is between the two modes.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. An internal combustion engine, comprising:
a first fuel injector configured to inject a first fuel into an engine cylinder in response to a first injection signal provided to the first fuel injector by an engine controller;
a second fuel injector configured to inject a second fuel into the engine cylinder in response to a second injection signal provided to the second fuel injector by the engine controller, the second fuel having a different reactivity than the first fuel;
a third fuel injector configured to inject a third fuel into the engine cylinder in response to a third injection signal provided to the third fuel injector by the engine controller, the third fuel having a different reactivity than the first and second fuels;
wherein the engine controller is configured to provide, as appropriate, the first, second and third injection signals using an engine speed and an engine load signals as primary control parameters such that the engine operates in at least two different combustion modes.

2. The internal combustion engine of claim 1, wherein the first fuel is injected directly into the engine cylinder, the second fuel is injected directly into the engine cylinder, and the third fuel is provided within an intake port of the engine cylinder and, during operation, is carried into the engine cylinder by incoming air or an air/exhaust gas mixture.

3. The internal combustion engine of claim 1, wherein the first, second and third fuels is selected from the group comprising: diesel, gasoline, natural gas, petroleum gas, and engine lubrication oil.

4. The internal combustion engine of claim 1, wherein the at least two different combustion modes include reactivity controlled compression ignition (RCCI) and distributed ignition (DI).

5. The internal combustion engine of claim 4, wherein the engine controller provides one first signal and a plurality of second signals for each combustion event to create stratified regions of air/fuel ratios having different reactivities within the engine cylinder when the engine is operating in the RCCI mode.

6. The internal combustion engine of claim 4, wherein the engine controller provides at least one of the first and second signals and a single third signal for each combustion event to create a relatively uniform region of air/fuel ratio that contains at least one of the first and second fuels within the engine cylinder, which relatively uniform region of air/fuel ratio ignites using droplets of the third fuel as an ignition source.

7. The internal combustion engine of claim 1, wherein an operating range of the engine includes a set of operating points, each operating point being characterized by a particular engine speed and a particular engine load, wherein a first operating mode of the two different operating modes is present when the engine is operating under a first subset of the set of operating points and wherein a second operating mode of the two different operating modes is present when the engine is operating under a second subset of the set of operating modes.

8. The internal combustion engine of claim 7, wherein the first and second subsets are discrete.

9. The internal combustion engine of claim 7, wherein the first and second subsets overlap along a third subset.

10. The internal combustion engine of claim 7, wherein the first subset encompasses operating points having relatively low engine speed and relatively low engine load, and wherein the second subset encompasses operating points having relatively high engine speed and relatively high engine load.

11. An internal combustion engine, comprising:
an engine cylinder formed in a cylinder case and at least partially defining a variable volume, the variable volume being in selective fluid connection with an air source via an intake port;
a first fuel injector configured to inject a first fuel directly into the variable volume;
a second fuel injector configured to inject a second fuel directly into the variable volume, the second fuel having a different reactivity than the first fuel;
a third fuel injector configured to inject a third fuel into the intake port, the third fuel having a different reactivity than the first and second fuels;
a speed sensor configured to provide an engine speed signal;
a load sensor configured to determine and provide an engine load signal;
a controller configured to receive and analyze the engine speed and load signals and provide a first injection signal to the first fuel injector, a second injection signal to the second fuel injector, and a third injection signal to the third fuel injector such that the engine operates in a first mode or a second mode as determined by the engine speed and load signals.

12. The internal combustion engine of claim 1, wherein the first, second and third fuels is selected from the group comprising: diesel, gasoline, natural gas, petroleum gas, and engine lubrication oil.

13. The internal combustion engine of claim 11, wherein the first mode is a reactivity controlled compression ignition (RCCI) combustion mode that is carried out only on the first and second fuels, and wherein the second mode is a distributed ignition (DI) combustion mode that is carried out using at least one of the first and second fuels, and the third fuel.

14. The internal combustion engine of claim 13, wherein the controller is configured to command the first and second fuel injectors to operate such that stratified regions of air/fuel ratios having different reactivities within the engine cylinder when the engine is operating are created.

15. The internal combustion engine of claim 13, wherein the controller is configured to command at least one of the first and second fuel injectors, and the third fuel injector, such that a relatively uniform region of air/fuel ratio that contains at least one of the first and second fuels is created within the engine cylinder, which relatively uniform region of air/fuel ratio ignites using droplets of the third fuel as an ignition source.

16. The internal combustion engine of claim 11, wherein an operating range of the engine includes a set of operating points, each operating point being characterized by a particular engine speed and a particular engine load, wherein the first mode is present when the engine is operating under a first subset of the set of operating points and wherein the second mode is present when the engine is operating under a second subset of the set of operating modes.

17. The internal combustion engine of claim 16, wherein the first and second subsets are discrete.

18. The internal combustion engine of claim 16, wherein the first and second subsets overlap along a third subset.

19. The internal combustion engine of claim 16, wherein the first subset encompasses operating points having relatively low engine speed and relatively low engine load, and wherein the second subset encompasses operating points having relatively high engine speed and relatively high engine load.

20. A method for operating an internal combustion engine, comprising:
monitoring engine speed and engine load signals;
determining a then-present operating point of the engine;
analyzing the then-present operating point of the engine;
determining whether at least a first operating mode or a second operating mode is desired based on the then-present operating point of the engine; and
when it is determined that the first operating mode is desired, sending appropriate commands to fuel injectors of the engine to inject fuels such that stratified regions of air/fuel mixtures having different reactivities are set up within an engine cylinder during operation, and
when it is determined that the second operating mode is desired, sending appropriate commands to fuel injectors of the engine to deliver a desired quantity of one or more than one fuel into the engine cylinder, and sending an appropriate command to an additional fuel injector to provide an ignition substance into an air inlet port of the engine cylinder.
